(19) United States
(12) Patent Application Publication
(10) Pub. No.: US 2006/0106535 A1
(43) Pub. Date: May 18, 2006

(54) Mapping system with improved flagging function

(76) Inventors: Jerry Richard Duncan, Bettendorf, IA (US); Bruce Edward Balentine, Denton, TX (US); Bruce Craig Newendorp, Cedar Falls, IA (US); Mark Steven Sommer, East Moline, IL (US); Wayne Farrior Smith, Clive, IA (US); Robert Lynn Mayfield, Cedar Falls, IA (US)

Correspondence Address: DEERE & COMPANY, ONE JOHN DEERE PLACE, MOLINE, IL, 61265, US

(21) Appl. No.: 10/989,171

(22) Filed: Nov. 15, 2004

(51) Int. Cl. G01C 21/30

(52) U.S. Cl. 701/208; 701/207

(57) ABSTRACT

A mapping system is movable over a terrain and operates to generate a map. The mapping system includes a geographical location unit generating location data, a timer generating time data, a pair of different interfaces for inputting flag data, such as a speech interface and a manual interface. The system also includes a processing unit connected to the geographical location unit and to the interfaces. The processing unit has a stored first delay time corresponding to the speech interface and having a stored second delay time corresponding to the manual interface. The second delay time is longer than the first delay time. The processing unit stores current time data and flag data in response to use of a selected one of the interfaces. The processing unit generates compensated time data as a function of the current time data and the delay time corresponding to the selected interface. The processing unit generates compensated location data as a function of the compensated time data. The processing unit stores the inputted flag data in association with the compensated location data.

### BACKGROUND

The present invention relates to a system and method for storing geographic location data and information associated with locations, such as during field mapping of an agricultural field.

When generating field maps for precision farming applications using a system with a manual data input device, the user associates or “flags” an event or an observation with a location on the map being created (such as recording the location of weeds on a crop yield map). A map generating system with a display and a complex menu hierarchy may require the user to press buttons in a certain sequence, and such systems may not record the location and associated information until the operator completes the manual entry of all the information. Thus, there can be a significant time delay between the time when the vehicle was at the particular location and the time at which the location and associated information is recorded. If the tractor is moving during this time, the recorded location coordinates will differ from the actual location, and the resulting field maps will be inaccurate.

Such systems are also prone to errors because users can forget to set and/or unset their flags using the button pressing interface. This results in unsatisfactory yield maps. Also, manual flagging or event marking while operating a harvesting combine, or other complex, self-propelled agricultural machine, is an “eyes busy-hands busy” task for the machine operator and therefore the operator can't always invest time when needed to press the necessary buttons to record the desired event information.

Systems for flagging location and related information using automatic speech recognition (ASR) have been proposed. A map generating system with a speech recognition interface permits the user to quickly command the system to record or log location data and associated information for later analysis on a yield map. While speaking commands to a speech recognition interface, the operator can perform other manual tasks in a timely manner. Such systems are described by D. L. Dux, R. M. Strickland, and D. R. Ess, “Generating Field Maps From Data Collected By Speech Recognition”, ASAE Paper 991099, Jul. 18-21, 1999; and by D. L. Dux, R. M. Strickland, D. R. Ess, and H. A. Diefes, “Comparison Of Speech Recognition Products For Data Collection”, ASAE Paper 993186, Jul. 18-21, 1999.) These publications describe the use of GPS coordinates to place location “marks” in a field map, and also discuss using ASR to input the specific events or information associated with the “marks.” The emphasis of the publications was on making the ASR technology portable and on ensuring high accuracy with the technology.

U.S. Pat. No. 5,870,689, issued in 1999 to Hale, et al., describes a scouting system for an agricultural field. The system includes a vehicle such as a combine or tractor equipped with a tool for working the field, a sensing circuit which detects a characteristic such as crop yield. The system also includes an input device for marking the positions of visible elements associated with the field, and a location signal generation circuit which generates signals relating to the locations at which the characteristic is sampled and to the positions of the visible elements. The system includes a user interface which includes a graphical user interface (GUI) providing cursor control (e.g., a mouse, joystick or four-way switch with up, down, right and left positions), assignable configurable switches (e.g., push buttons), a keyboard, and a voice-communication interface. Characteristic data are correlated with the locations at which the characteristic was sampled, and scouting data representative of the visible elements are correlated with the positions of the visible elements. The correlated data are stored in a memory. A display may show a field map including characteristic values, visible elements and definitions of the re-definable switches.

In any such data recording system there is always some delay between the time a user sees and recognizes a feature in a field and the time the feature information can be inputted, either manually or orally. If the data recording system is on a moving vehicle, then the system will have moved a certain distance during this delay time, and the recorded location data will be different from the location at which the user first recognized the feature, and the resulting map will not be accurate.

Also, ASR technology is unreliable and produces errors, such as when the wrong words are spoken or spoken words are misinterpreted by the speech recognition system. Such errors are normally corrected by the user engaging in a dialog with the speech recognition system, but such a dialog is time consuming. Correcting non-recognition errors often requires repetition. Faulty user memory can result in error with either a speech or manual input system.

### SUMMARY

Accordingly, an object of this invention is to provide a mapping system with a flagging function which compensates for the delay between the time a user sees and recognizes a feature in a field and the time the feature information can be inputted.

Another object of this invention is to provide such a system which compensates for different delay times depending upon whether the feature information is inputted manually or orally.

These and other objects are achieved by the present invention, wherein a mapping system includes a geographic location unit for generating location data representing a geographical location of the vehicle. The system also includes a microphone and an automatic speech recognition (ASR) interface for inputting flag data spoken by the user, a manual interface for manually inputting flag data, and a control or processing unit connected to the location unit and to the interfaces for receiving, processing and storing information therefrom. Flag data relates to features associated with user identified locations. The control unit includes a timer for generating time data. As the mapping system moves over a terrain, it continuously stores time data and associated geographical location data in a buffer memory for a recent time period. The control unit, in response to initiation of input of flag data by the user, stores current time data corresponding to a time of initiation of flag data input by the user. Upon completion of flag data input by the user, the control unit calculates revised or compensated location data based on the stored current time data and a predetermined delay time. The delay time varies depending upon whether the speech or manual interface is used.

### BRIEF DESCRIPTION OF THE DRAWINGS

FIG. 1 is a simplified schematic diagram of a field map generating system; and

FIG. 2 is logic flow diagram illustrating an algorithm executed by the computer FIG. 1.

### DETAILED DESCRIPTION

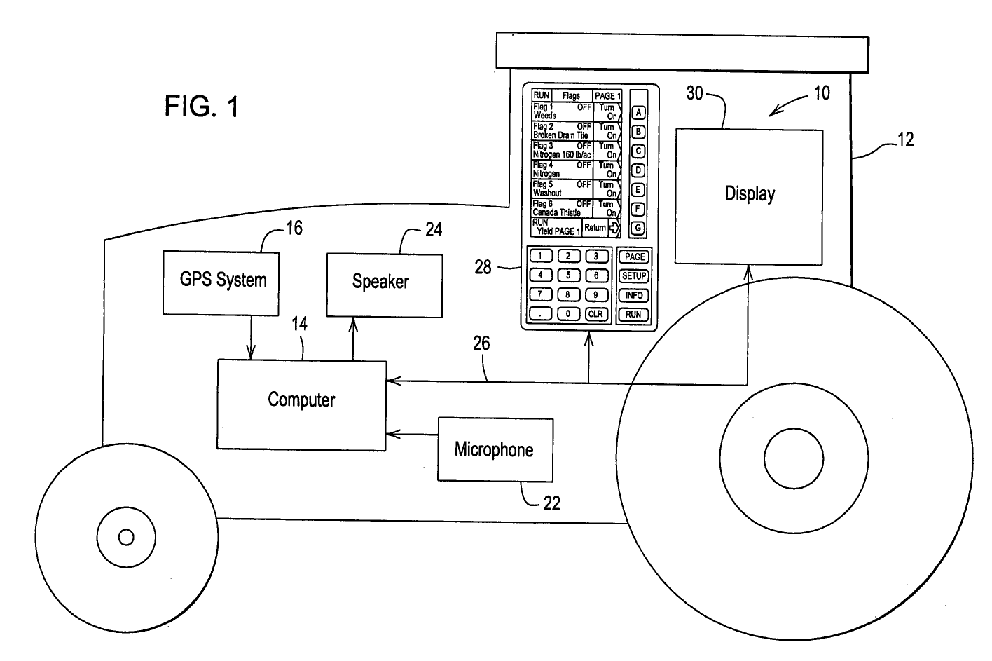

Referring to FIG. 1, a field map generating or mapping system 10 is mounted on a vehicle 12 which may be driven over an area of land such as a cornfield or undeveloped property, but may be any other space, including forests, bodies of water, mountainous terrain, or underground area. The system 10 includes a microprocessor-based processing unit or computer 14 which receives continuously updated location data, preferably from a conventional commercially available GPS unit 16, or some other type of location system, such as an inertial-guidance system.

The system 10 includes a speech interface or microphone 22 connected to the computer 14. Computer 14 may provide an audio signal to a speaker 24. The system 10 also includes a manual interface 28 connected by a communications link 26 to computer 14, such as a display/control/touch pad unit (preferably such as a commercially available John Deere GreenStar™ unit). In addition or alternatively, the computer 14 may be connected to another display/touch screen unit 30. Interface 28 is preferably configured to include manual interface or input devices, such as manual flagging buttons, or switches 18. Alternatively, the system 10 could include separate stand alone or dedicated flagging buttons or switches (not shown).

The computer 14 includes an internal software clock or timer (not shown) and a buffer memory (not shown). The computer 14 continuously and repeatedly stores in the buffer memory a plurality of time values from the timer and the GPS location data from GPS unit 16 associated with each time value. Preferably, time values and location data are stored and renewed or updated so that the buffer contains data for a time interval appropriate to the operator's activity (e.g., the previous 90 seconds for noting a flag while operating a harvesting combine).

The computer 14 also executes conventional speech recognition software to process the audio signals from the microphone 22. The speech recognition function is preferably initiated in response to the user speaking into the microphone 22. Alternatively, the system could include a press-to-talk button or switch (not shown) which could be actuated to inform the computer 14 that a speech input is forthcoming. The system could also include other input subsystems, such as eye-motion detection and tracking, foot pedals, and gesture detectors (not shown).

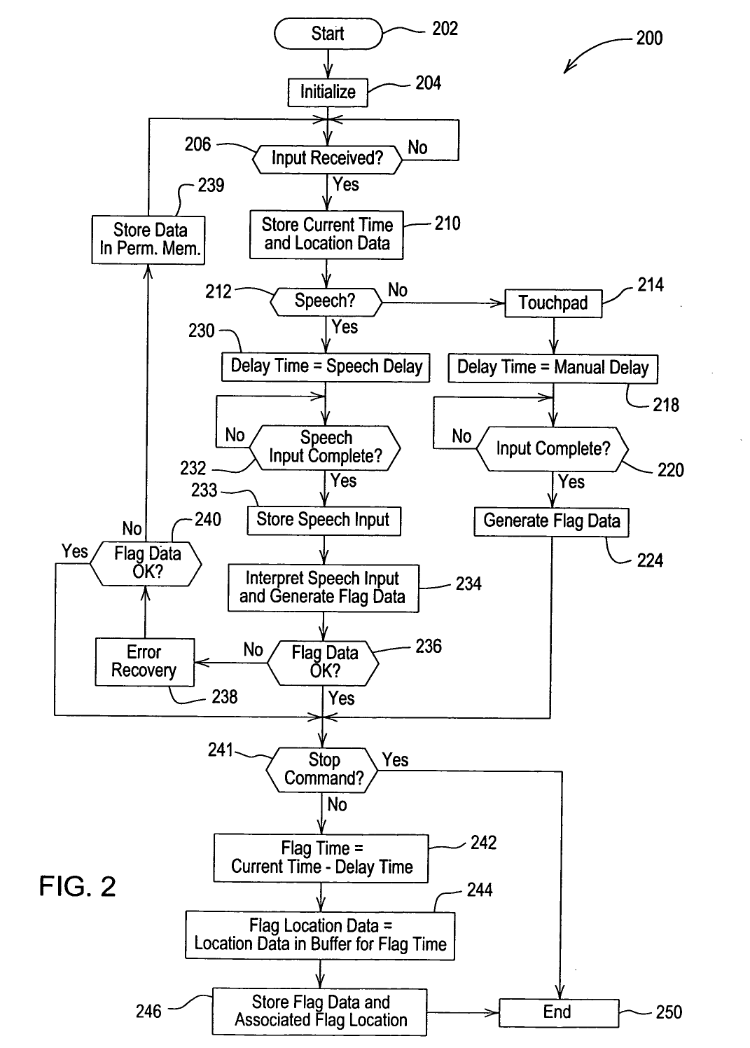

Referring now to FIG. 2, the computer 14 also executes a flagging algorithm 200 which processes and stores “flag” data which represents various features in an agricultural field over which the vehicle 10 moves. A flag may be a “point mark” to mark a specific point in the field, or a flag may be an “area mark” to mark the boundary of an area where a certain condition applies. The conversion of the flow chart of FIG. 2 into a standard language for implementing the algorithm described by the flow chart in a digital computer or microprocessor, will be evident to one with ordinary skill in the art.

After starting at step 202 and initialization at step 204, step 206 causes the algorithm to wait until an input is received from either (speech interface) microphone 22 or from (manual interface) touch pad inputs from display/control unit 8 or display 28. If an input is received, subroutine 206 directs the algorithm to step 210 which stores in a temporary memory location the Current Time and the Current Location data from GPS unit 16.

If the input was a speech input via microphone 22, step 212 directs the algorithm to step 230, else to step 214.

If the input was a manual input via a touch pad input, step 214 directs the algorithm to step 218 which sets a Delay Time value equal to a predetermined stored Manual Delay Time, such as 2 seconds. This Manual Delay Time is selected to compensate for the time lags associated with several human and physical properties, including the time required to notice (attend to) an event, form a decision to record it, and press a button, causing the recording system to note the start of data entry.

As mentioned previously, the system may include other inputs (not shown). If so, the algorithm 200 may be augmented to include additional processing steps (not shown) and additional delay times (not shown) for such other inputs.

After step 218, step 220 causes the algorithm to wait until the manual input is completed, whereupon step 224 generates and stores flag data associated representing the feature, event or thing being flagged by the user.

Referring back to step 212, if the input was a result of a speech input from microphone 22, step 212 directs the algorithm to step 230.

Step 230 sets the Delay Time value equal to a predetermined stored Speech Delay Time, such as 1.5 seconds. This Speech Delay Time is selected to compensate for the time lags associated with several human and physical properties, including the time required to notice (attend to) an event, form a decision to record it, and speak a message into the microphone 22, causing the system to note the start of data entry. The Speech Delay Time will normally be shorter than the Manual Delay Time.

Step 232 causes the algorithm to wait until the speech input is completed, whereupon step 233 stores the native unprocessed speech input in a temporary memory location.

Step 234 interprets the stored speech input using known speech recognition techniques, and generates flag data representing the feature, event or thing being flagged or described by the user's speech. There are a number of such techniques well-known in the art such as yes-no questions, re-prompting for new speech, traversing n-best lists, and so forth. Such dialogues might take quite a long time to complete. The end result is either success or failure. Although not illustrated by FIG. 2, the algorithm could be designed to make it possible to perform, at a later time, further speech processing of the speech input stored by step 233, if desired.

Step 236 checks the validity of the flag data stored in step 234 and directs the algorithm to step 238 if the stored flag data is in error, else to step 241. Step 238 attempts to correct erroneous flag data. If step 238 fails to correct the flag data, step 240 directs the algorithm to step 239 which stores in a permanent memory location (not shown—such as a hard disk or flash memory) the data temporarily stored at steps 210 and 233, and then returns the algorithm to step 206 to await another flagging input. This permanently stored data can then be further processed at a later time.

Step 241 directs the algorithm to end at step 250 if the flag is a stop command, else to step 242.

Step 242 sets a Flag or compensated Time value equal to the Current Time—Delay Time, where Current Time is the time value stored at step 210 and Delay Time is the Speech Delay Time or the Manual Delay Time from either step 230 or step 218.

Next, step 244 retrieves from the buffer of computer 14 the location data in the buffer of computer 14 associated with the Flag Time calculated in step 242 and designates this as the compensated or Flag Location Data.

Finally, step 246 stores the Flag Data and associated Flag Location Data in the computer 14 as part of the map being created by the system 10. This stored Flag Location will thereby be compensated for delays and time lags resulting from the time it takes a user to initiate a flagging input, either via speech or manually.

### MODE OF OPERATION

A user observes some object, condition, or event. A farmer, for example, might notice an unwanted rock, poor water drainage, damage to a tile or structure, evidence of pests such as weeds or insects, animal damage, or any other interesting phenomenon in a field being harvested or mapped for making a management decision. The user intends to report this phenomenon for later use—for example to determine amount and location of herbicide or pesticide, to dispatch a repair or removal team, or to assess the impact of the phenomenon on crop yield. To enter this information in a timely way, the user interacts with the algorithm 200 by speaking into microphone 22 or touching a touch pad on unit 28, or manually actuating some other input device connected to the system, such as clicking a wireless handheld clicker (not shown).

This user input is detected by step 206, and step 210 stores the precise moment in time when the input was detected in association with the spatial location as determined by the GPS unit 16. After storing this information, the system continues to monitor the user's movement through the space until such time as the user inputs are completed and processed. The processing time may be of variable duration. For a manual input, the processing time might be very short—on the order of 100 to 500 milliseconds. But for a speech input, the input cannot be considered complete until the user has finished speaking and the automatic speech recognizer (ASR) has finished processing the speech. This can be as much as five seconds or longer depending on the number of words spoken and whether or not any error-recovery dialogue was necessary.

Steps 212 and 214 determine whether the user is making a speech or manual touchpad input. Because each input modality will normally have different latencies or delay times, steps 218, 230, 242 and 244 operate to determine any offset from the original stored spatial coordinates that may be required to accurately represent to the true location of the event or thing being flagged. For example, the time elapsed from the moment of observing a phenomenon to the moment of speaking or pressing a button may extend from a few hundred milliseconds to several seconds, depending on the conditions and the context of the user's task. During this elapsed time, the tractor and the user are moving. Although the error in coordinates may be negligible for many applications, there are conditions in which the error becomes substantial, such as when the user is moving very quickly, the user is operating a remote vehicle that contains the positioning unit, the user must “look up” key combinations or speech utterances to learn how to report the phenomenon, or similar special cases.

Step 244 associates the newly-computed flag time with the corrected spatial coordinates. Step 246 stores a “mark” by storing the event or flag information and the associated corrected coordinates as a data record. When reviewing the data later, the user will see on the field map (not shown) that an object, condition, or event represented by the flag is located at a specific point on the map.

While the present invention has been described in conjunction with a specific embodiment, it is understood that many alternatives, modifications and variations will be apparent to those skilled in the art in light of the foregoing description. For example, the GPS unit could be replaced by another device which tracks position by measuring direction and speed of motion, distance from a reference, or any other means. The user may carry or wear the system, drive a vehicle equipped with the system, walk or drive adjacent to a vehicle containing the system.

When a key-word or phrase is spoken to initiate the speech recognition flag-setting function, a “flag” or mark is made and stored that defines the place and time of the event. The label of the mark is defined by the word stated by the operator (i.e., the word spoken or key-word is used as the marker label) so that the intended mark can be more accurately designated for association with a location. That is, the location of the mark is not affected by the display menu navigation time of the operator, the computer processing time or possible error-handling time of a speech recognition system.

The system and algorithm may be modified to include a hand-held one-shot “clicker” (not shown) and a portable microphone (not shown) communicated with the computer for use by a user walking through a field. Upon observing a situation to be flagged, such as button weeds, the user clicks to initiate a flagging action. The user then speaks “button weeds” into the portable microphone, and the system determines a time delay at the end of the speech. The system would use this time delay to determine corrected time-adjusted location coordinates. A “button weeds” flag will then be associated with the corrected time-adjusted location coordinates.

The system described above may also be modified to associate multiple sequentially spoken or manually inputted flags with a single location, such as “button weeds” followed by “nightshade”, but both associated with the same field location.

Accordingly, this invention is intended to embrace all such alternatives, modifications and variations which fall within the spirit and scope of the appended claims.

We claim:

1. A method of flagging information in a mapping system movable over a terrain, the mapping system having a geographical location unit generating location data and having a plurality of data input interfaces, and a processing unit connected to the geographical location unit and to the interfaces and generating a map, the method comprising the following steps:
in response to initiation of flag data input through one of the interfaces, storing current time data;
upon completion of flag data input through the interface, analyzing the flag data and storing resulting flag data;
determining compensated time data as a function of the stored current time data and a time delay depending upon which of the interfaces is being used;
determining compensated location data as a function of the compensated time data; and
storing the compensated location data in association with the stored resulting flag data.

2. The method of claim 1, wherein:
the interface comprises a speech interface including a microphone and the processing unit performs a speech recognition function.

3. The method of claim 1, wherein:
the interface comprises a manual interface manipulated by a hand or fingers of the user.

4. The method of claim 3, further comprising:
a speech interface comprising a microphone and the processing unit performs a speech recognition function.

5. The method of claim 4, further comprising:
using a first predetermined delay time when the speech interface is used by the user; and
using a second predetermined delay time when the manual interface is used by the user.

6. The method of claim 5, wherein:
the first predetermined delay time is shorter than the second predetermined delay time.

7. The method of claim 1, wherein:
the interface comprises a speech interface including a microphone and the processing unit performs a speech recognition function to produce a resulting speech input; and
if the resulting speech input is erroneous, the processing unit executing an error correcting process to produce a correct resulting speech input.

8. The mapping system of claim 7, wherein:
if the error correcting process produces a correct resulting speech input, storing the correct resulting speech input, and associating the correct resulting speech input with the revised location data.

9. The mapping system of claim 7, wherein:
if the error correcting process is unable to produce a correct resulting speech input, storing the compensated location data and the resulting speech input in permanent memory.

10. A mapping system movable over a terrain, the mapping system comprising:
a geographical location unit generating location data;
a timer generating time data;
a first user operable data input interface for inputting flag data;
a second user operable data input interface different from the first interface for inputting flag data;
a processing unit connected to the geographical location unit and to the interfaces and generating a map, the processing unit having a stored first delay time corresponding to the first interface and having a stored second delay time corresponding to the second interface, the second delay time being different from the first delay time, the processing unit storing current time data and flag data in response to use of a selected one of the interfaces, the processing unit generating compensated time data as a function of the current time data and the delay time corresponding to the selected interface, and the processing unit generating compensated location data as a function of the compensated time data, the processing unit storing the inputted flag data in association with the compensated location data.

11. The mapping system of claim 10, wherein:
one of the interfaces comprises a speech interface including a microphone and the processing unit performs a speech recognition function.

12. The mapping system of claim 10, wherein:
one of the interfaces comprises a manual interface manipulated by a hand or fingers of the user.

13. The mapping system of claim 12, further comprising:
the other interface comprises a speech interface comprising a microphone and the processing unit performs a speech recognition function.

14. A mapping system movable over a terrain, the mapping system comprising:
a geographical location unit generating location data;
a timer generating time data;
a speech interface including a microphone for orally inputting flag data;
a manual interface for manually inputting flag data;
a processing unit connected to the geographical location unit and to the interfaces and generating a map, the processing unit having a stored first delay time corresponding to the speech interface and having a stored second delay time corresponding to the manual interface, the second delay time being longer than the first delay time, the processing unit storing current time data and flag data in response to use of a selected one of the interfaces, the processing unit generating compensated time data as a function of the current time data and the delay time corresponding to the selected interface, and the processing unit generating compensated location data as a function of the compensated time data, the processing unit storing the inputted flag data in association with the compensated location data.
